(19) United States
(12) Patent Application Publication
(10) Pub. No.: US 2026/0127501 A1
(43) Pub. Date: May 7, 2026

(54) METHOD AND DEVICE FOR DIFFUSING COMMUNICATIVELY EFFICIENT ARTIFICIAL INTELLIGENCE MODELS FOR IMPROVING PERFORMANCE OF FEDERATED LEARNING SYSTEM

(71) Applicant: INDUSTRY-UNIVERSITY COOPERATION FOUNDATION HANYANG UNIVERSITY ERICA CAMPUS, Ansan-si (KR)

(72) Inventors: Sunghyun CHO, Seoul (KR); Seyoung AHN, Ansan-si (KR); Soohyeong KIM, Ansan-si (KR); Yongseok KWON, Ansan-si (KR)

(73) Assignee: INDUSTRY-UNIVERSITY COOPERATION FOUNDATION HANYANG UNIVERSITY ERICA CAMPUS, Ansan-si (KR)

(21) Appl. No.: 19/393,186

(22) Filed: Nov. 18, 2025

Related U.S. Application Data
(63) Continuation of application No. PCT/KR2023/095031, filed on Jul. 13, 2023.

(30) Foreign Application Priority Data
May 18, 2023 (KR) 10-2023-0064097

(51) Int. Cl. G06N 20/00

(52) U.S. Cl. CPC G06N 20/00

(57) ABSTRACT

Provided is a method of operating a user equipment (UE) for artificial intelligence (AI) model diffusion in a federated learning (FL) system. The method operating the UE includes receiving a copy of a global model from a central server, building a local model based on the copy of the global model and performing training of the local model using acquired data to acquire a first local model, updating the first local model to a second local model through local training based on local diffusion, and transmitting the second local model to the central server.

### CROSS-REFERENCE TO RELATED APPLICATION

This application claims priority to and the benefit of Korean Patent Application No. 10-2023-0064097, filed on May 18, 2023, the present disclosure of which is incorporated herein by reference in its entirety.

### BACKGROUND

### 1. Field of the Invention

The present disclosure relates to a communication-efficient artificial intelligence (AI) model diffusion method and apparatus for improving the performance of a federated learning system, and more specifically, to a communication-efficient AI model diffusion method and apparatus for improving the performance of a federated learning system, which includes a new diffusion strategy for transmitting and receiving AI models between users prior to aggregation of the AI models.

### 2. Discussion of Related Art

In next-generation mobile communication systems, as a large number of communication devices demand large communication capacity, various technologies have been proposed to meet the requirements of enhanced mobile broadband (eMBB), massive machine type communications (mMTC), and ultra-reliable and low latency communications (URLLC) services, which are improved services compared to a conventional radio access technology (RAT).

In addition, in the next-generation mobile communication systems, artificial intelligence (AI) or machine learning may be taken into consideration, and based on this, a federated learning (FL) may be applied. FL is a new learning paradigm that addresses the problem of personal information leakage in centralized learning and may provide functions of protecting personal privacy, reducing the load on a base station through distributed processing, and reducing traffic between the base station and terminals. FL may be a distributed learning technique that can train a model using distributed data held by multiple users. That is, FL may utilize distributed data of multiple users. Here, when there exists, among the multiple users, a specific user having non-independent and identically distributed (Non-IID) characteristics, the performance of FL may be degraded, and a method for solving this will be described below.

### RELATED ART DOCUMENT

### Patent Document

Korean Laid-Open Patent Publication No. 10-2022-0168128 A

### SUMMARY

The present disclosure is directed to providing a communication-efficient artificial intelligence model diffusion method and apparatus for improving the performance of a federated learning (FL) system.

The present disclosure is also directed to providing a method and apparatus for performing optimization to improve the performance of an FL system by utilizing a degree of learning (DoL) of an artificial intelligence (AI) model and an independent and identically distributed (IID) distance with respect to a proximity of the DoL to an identically distributed distribution.

The present disclosure is also directed to providing a method and apparatus for improving performance by adding a local diffusion process to an FL system.

The present disclosure is also directed to providing a method and apparatus for a specific operation of a local diffusion process.

According to an aspect of the present disclosure, there is provided a method of operating a user equipment (UE) for AI model diffusion in an FL system, which includes receiving a copy of a global model from a central server, building a local model based on the copy of the global model and acquiring a first local model by performing training of the local model using acquired data, updating the first local model to a second local model through local training based on local diffusion, and transmitting the second local model to the central server.

According to another aspect of the present disclosure, there is provided a UE that performs AI model diffusion in an FL system and includes a memory, a transceiver, and a controller configured to control the memory and the transceiver, wherein the controller may be configured to receive a copy of a global model from a central server, build a local model based on the copy of the global model, perform training of the local model using acquired data to acquire a first local model, update the first local model to a second local model through local training based on local diffusion, and transmit the second local model to the central server.

According to still another aspect of the present disclosure, there is provided a method of operating a central server for AI model diffusion in an FL system, the method including transmitting a copy of a global model to a plurality of UEs participating in FL, wherein each of the plurality of UEs builds a local model based on the copy of the global model and performs training of the local model using data acquired by each of the plurality of UEs, determining a next trainer UE by receiving a candidate IID distance from each of the plurality of UEs based on local training, transmitting scheduling information based on the determined next trainer UE to the plurality of UEs participating in the FL, and updating the global model by acquiring local models trained based on the local training from the plurality of UEs.

According to yet another aspect of the present disclosure, there is provided a central server that performs AI model diffusion in an FL system, the central server including a memory, a transceiver, and a controller configured to control the memory and the transceiver, wherein the controller may be configured to transmit a copy of a global model to a plurality of UEs participating in the FL system, each of the plurality of UEs building a local model based on the copy of the global model and performing training of the local model using data acquired by each of the plurality of UEs, determine a next trainer UE by receiving a candidate IID distance from each of the plurality of UEs based on local training, transmit scheduling information based on the determined next trainer UE to the plurality of UEs participating in the FL system, and update the global model by acquiring local models trained based on the local training from the plurality of UEs.

Here, the following matters may be commonly applied.

According to an embodiment of the present disclosure, the UE may be a UE participating in the FL system based on the central server.

In addition, according to an embodiment of the present disclosure, when local training is performed in a first diffusion round, the UE may transmit a DoL to the plurality of UEs participating in the FL system based on the central server, wherein the DoL may represent a cumulative data distribution learned through data acquired based on the local model.

In addition, according to an embodiment of the present disclosure, the DoL may be transmitted to the plurality of UEs participating in FL system using a broadcasting scheme.

In addition, according to an embodiment of the present disclosure, the DoL may be transmitted to the central server through an uplink control channel, and the central server may transmit the DoL to the plurality of UEs participating in FL through a downlink control channel.

In addition, according to an embodiment of the present disclosure, the UE may receive a DoL from each of the plurality of UEs participating in the FL, generate a preliminary DoL by reflecting data state information (DSI) of the first local model in each DoL, and derive a first IID distance based on the preliminary DoL and transmit the derived first candidate IID distance to the central server.

In addition, according to an embodiment of the present disclosure, the central server may derive bidding price information by deriving a difference value between a the first candidate IID and a second candidate IID, which is derived in a second diffusion round, wherein the second diffusion round is a diffusion round prior to the first diffusion round, and the central server may derive bidding price information for each of the plurality of UEs participating in the FL and determine a next trainer UE through UE valuation.

In addition, according to an embodiment of the present disclosure, the central server may determine the next trainer UE through UE valuation by further considering channel state information (CSI) for each of the plurality of UEs.

In addition, according to an embodiment of the present disclosure, when the UE is determined as the next trainer UE, the UE may transmit the first local model to the plurality of UEs participating in the FL in a device-to-device (D2D) manner.

In addition, according to an embodiment of the present disclosure, when receiving, from the next trainer UE, a local model of the next trainer UE in the D2D manner, the UE may obtain a second local model by performing training based on the local model of the next trainer UE.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is a diagram illustrating a network environment applied to the present disclosure;

FIG. 2 is a diagram illustrating a device configuration applied to the present disclosure;

FIG. 3 is a diagram illustrating a conventional artificial intelligence model learning paradigm applicable to the present disclosure;

FIG. 4 is a diagram illustrating a federated learning (FL) paradigm applicable to the present disclosure;

FIGS. 5A and 5B are diagrams illustrating operations of degrading learning performance by personalized data, applicable to the present disclosure;

FIGS. 6A and 6B are diagrams illustrating a method of minimizing a diffusion efficiency by minimizing an independent and identically distributed (IID) distance with respect to user equipments (UEs) having non-independent and identically distributed (non-IID) datasets, applicable to the present disclosure;

FIGS. 7A and 7B are graphs comparing learning performance and communication costs, applicable to the present disclosure;

FIGS. 8A and 8B are graphs comparing learning performance and communication costs, applicable to the present disclosure;

FIGS. 9A and 9B are graphs comparing learning performance and communication cost, applicable to the present disclosure;

FIG. 10 is a diagram illustrating a federated diffusion (FedDif) operation procedure applicable to the present disclosure;

FIG. 11 is a flowchart illustrating a communication-efficient artificial intelligence model diffusion method for improving performance of an FL system, applicable to the present disclosure; and

FIG. 12 is a flowchart illustrating a communication-efficient artificial intelligence model diffusion method for improving performance of an FL system, applicable to the present disclosure.

### DETAILED DESCRIPTION OF EXEMPLARY EMBODIMENTS

The detailed description set forth below in connection with the appended drawings is intended as a description of various embodiments of the present disclosure and is not intended to represent the only embodiments in which the present disclosure may be practiced. The detailed description includes specific details for the purpose of providing a thorough understanding of the present disclosure. However, it will be apparent to those skilled in the art that the present disclosure may be practiced without these specific details.

The following embodiments are combinations of components and features of the embodiments in a predetermined form. Each component or feature may be considered optional unless explicitly stated otherwise. Each component or feature may be implemented without being combined with other components or features. In addition, various embodiments may be configured by combining some components and/or features. The order of operations described in various embodiments may be changed. Some components or features of one embodiment may be included in another embodiment, or may be replaced with corresponding components or features of another embodiment.

Specific terms used in the following description are provided to aid in understanding the present disclosure, and the use of such specific terms may be changed to other forms without departing from the technical spirit of the present disclosure.

In some cases, in order to avoid obscuring the concepts of the present disclosure, well-known structures and devices are omitted or illustrated in the form of block diagrams focusing on core functions of each structure and device. In addition, the same components are described using the same reference numerals throughout the present specification.

In addition, while terms such as “first” and/or “second” may be used herein to describe various components, these components should not be limited by these terms. These terms are used solely to distinguish one component from another. For example, without departing from the scope of the concepts of the present specification, a first component may be referred to as a “second component,” and similarly, a second component may also be referred to as a “first component.”

Furthermore, throughout the present specification, when a part is described as “including” a certain component, this means that, unless expressly stated otherwise, it does not exclude the presence of one or more other components, but may further include other components. In addition, terms such as “unit” and “module” as used in the specification refer to a unit that processes at least one function or operation and may be implemented as a combination of hardware and/or software.

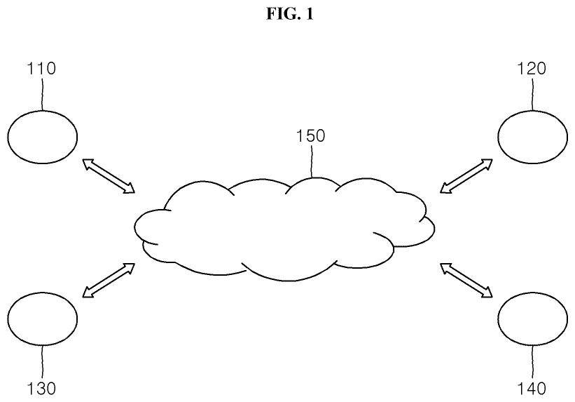

FIG. 1 is a diagram illustrating a network environment applied to the present disclosure.

Referring to FIG. 1, devices 110, 120, 130, and 140 may be connected via a network 150. For example, the devices 110, 120, 130, and 140 may be connected to at least one device or server via a wireless network 150, thereby transmitting and receiving data. In addition, the devices 110, 120, 130, and 140 or a user equipment (UE) may be a mobile device or stationary device. Specifically, the devices 110, 120, 130, and 140 may be mobile devices such as smart phones, tablets, or wearable devices. In addition, the devices 110, 120, 130, and 140 may be stationary devices such as computers, laptops, and PCs. As another example, the devices 110, 120, 130, and 140 may be Internet of things (IoT) devices, virtual reality (VR)/augmented reality (AR) devices, and other devices, and are not limited to a specific embodiment.

In addition, the server may be a device having a function of providing content or services while being connected to one or more devices via the network 150. In a specific example, the server may provide a service or a response to a request to at least one device that accesses the server via the network 150. Here, the server may be interworked based on software or an application installed in each of the at least one device, thereby providing the service.

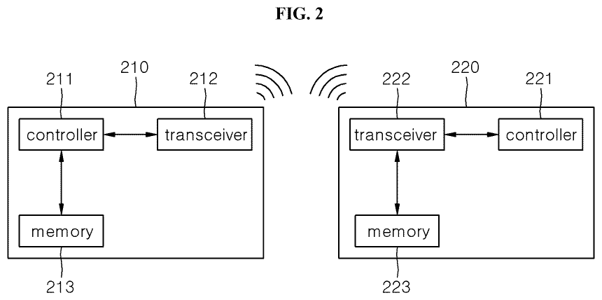

FIG. 2 is a diagram illustrating a device configuration applied to the present disclosure. Referring to FIG. 2, a device 210 may include a controller 211, a transceiver 212, and a memory 213. The device 210 may further include components other than the above-described components. The device 210 of FIG. 2 may transmit and receive data through communication with another device 220 and may be a UE. For example, the device 210 may collectively refer to a device such as a smartphone, a smart pad, a notebook, a PC, or another communication-capable device and is not limited to a particular device.

For example, the controller 211 of the device 210 may be configured to execute and process commands related to driving or operation of the device 210. The controller 211 may be a logical entity that controls the transceiver 212 and other components, and is not limited to a particular embodiment. The controller 211 of the device 210 may be configured to process instructions of a computer program by performing arithmetic, logical, and input/output operations. For example, the instructions may be provided to the controller 211 based on signals stored in the memory 213 or acquired through the transceiver 212, and the controller 211 may perform operations based on the instructions.

The transceiver 212 may provide a function of communication with at least one of another device 220 and a server via a network. For example, another device 220 may also include a controller 221, a transceiver 222, and a memory 223. Another device 220 may also be any of the above-described smart device, a PC, and another communication-capable device and is not limited to a particular embodiment.

In addition, for example, the device 210 may further include an input unit (not shown) and an output unit (not shown). Here, the input unit may be a keyboard, a mouse, a touchpad, a camera, or another component that provides input signals, and the output unit may be a display, a speaker, or another component that provides output signals. However, the present disclosure is not limited thereto. An external output device may include a display, a speaker, a haptic feedback device, or other devices.

The memory 213 is a non-transitory computer-readable recording medium and may include a permanent mass storage device such as a random access memory (RAM), a read-only memory (ROM), a disk drive, a solid state drive (SSD), or a flash memory, but is not limited to a particular form. In addition, the memory 213 may store commands or program codes related to driving or operation of the device 210. The memory 213 may also store an operating system and other software of the device 210. For example, the device 210 may use software loaded from a computer-readable recording medium of a separate computer. Here, the computer-readable recording medium may include a floppy drive, a disk, a tape, a DVD/CD-ROM drive, a memory card, and other recording media, and is not limited to a particular embodiment.

Hereinafter, a UE as the device 210 or 220 of FIG. 2 will be described. In the following description, each UE may communicate with a base station or a central server, and an artificial intelligence (AI) model may be implemented in the base station or the central server and shared with each UE. For example, the base station or the central server may be a base station of a 5G communication system, a 6G base station for a next-generation communication system, or any other type of node or server. In other words, the base station or the central server is merely an entity that is connected to the UE and trains an AI model based on federated learning (FL) and may not be limited to a particular form. Hereinafter, for the convenience of explanation, the base station or the central server is referred to as a central server. However, this is only a name for the convenience of explanation and is not limited thereto, and other forms are also possible.

In a wireless communication network or a wireless local area network (WLAN), an FL system for jointly training a single AI model based on a plurality of UEs may be applied. Here, the UE may include not only a smartphone but also any terminal having computing capability capable of performing AI learning, producing personalized data, and accessing a network, and each of the devices of FIG. 2 described above may correspond to the UE.

Here, for example, the AI model may be an AI model that uses personalized data. In a specific example, the AI model may be trained based on a classification problem of classifying data into C classes (C-class classification problem). For example, the C-class classification problem may refer to learning to predict that input data belongs to one of C classes, and C may denote the number of classes. Here, the AI model that operates based on the C-class classification problem may learn a function of analyzing input data and predicting a probability of belonging to each class, and training may be performed by the above-described FL. However, the classification problem of classifying into C classes is merely one example, and is not limited thereto, and may be applied to other AI models.

In the FL, a global model, which is the AI model of the central server, is copied and transmitted to a plurality of UEs, and each UE may perform training of the received global model by utilizing its own data.

More specifically, the plurality of UEs may perform training of a local model built in each UE based on the global model using their own data. Thereafter, each of the plurality of UEs may transmit information on the trained local model to the central server. The central server may update the global model based on the local model received from each of the plurality of UEs. The FL may train the global model without collecting data from UEs (or users) by repeating the above-described series of processes.

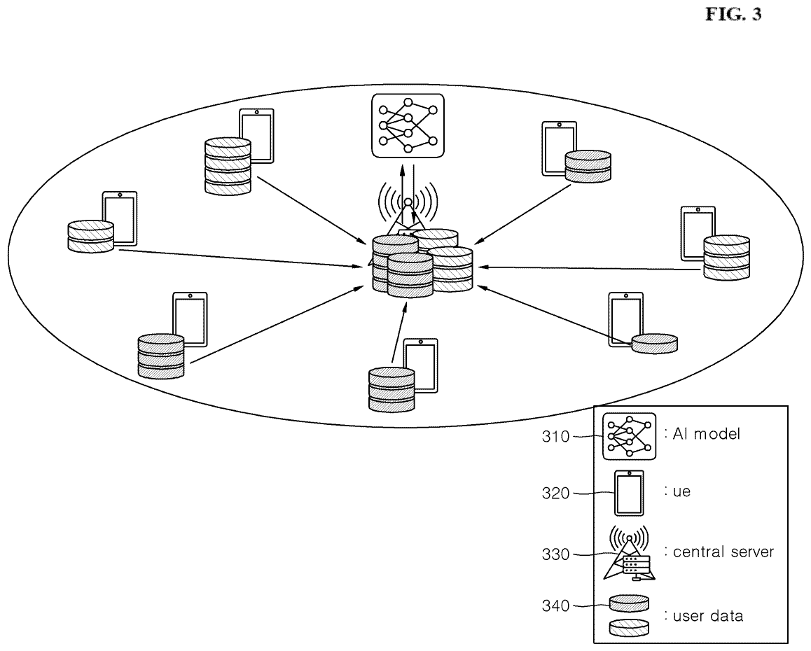

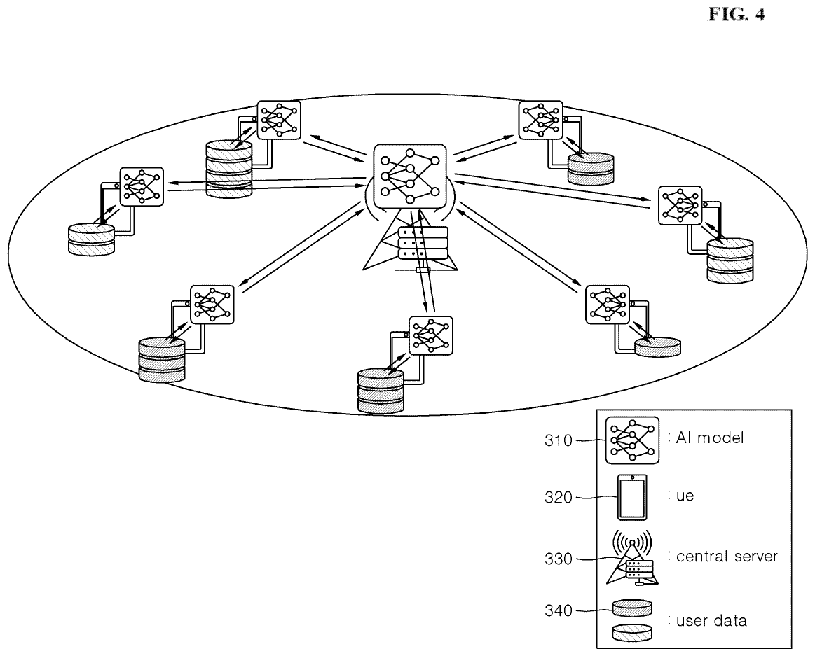

For example, FIG. 3 is a diagram illustrating a conventional AI model learning paradigm applicable to the present disclosure, and FIG. 4 is a diagram illustrating an FL paradigm applicable to the present disclosure. Referring to FIG. 3, an AI model 310 may be built in a central server (or base station, 330). The central server 330 may collect user data 340 from each of a plurality of UEs 320 and train the AI model 310 based on the collected data. For example, a conventional AI model learning paradigm may form an independent and identically distributed (IID) data set during the process of collecting and verifying the user data 340 in the central server 330, and may train the AI model based on the formed data set. However, in the above-described approach, there is a problem in that user data privacy may be infringed by an entity that manages the central server and a large communication cost may be incurred in the process of collecting the user data 340.

On the other hand, referring to FIG. 4, in the FL paradigm, the central server 330 may share the built AI model 310 with the plurality of UEs 320, and each of the plurality of UEs 320 may build a local model and perform training individually based on the AI model 310 received from the central server 330. Thereafter, the plurality of UEs 320 may transmit information on training results obtained by performing training to the central server 330, and the central server 330 may update the AI model 310 based on the training result information received from each UE 320. That is, since the central server 330 does not directly acquire the user data 340 for each of the plurality of UEs 320, user data privacy may be protected, and communication traffic between the central server 330 and the plurality of UEs 320 may be reduced.

However, each of the plurality of UEs 320 may acquire the user data 340 based on its own purposes and tendencies. That is, when the user data 340 for the plurality of UEs 320 are compared with one another, there may exist a UE that exhibits non-independent identity distribution (non-IID) characteristics, such as being biased toward a specific class or producing extremely small amounts of data. Here, the training result information transmitted to the central server 330 by the UE 320 performing local training based on the non-IID data set may significantly degrade the learning performance of the global model as the AI model 310 of the central server.

More specifically, training of the AI model 310 proceeds through optimization that minimizes an error between a training data set and predictions of the AI model 310. Here, in a case in which the training results of the respective UEs differ significantly, when the central server 330 trains the AI model 310 based on the training result information, it may be impossible to perform optimization that minimizes the error, and accordingly, the performance may be degraded.

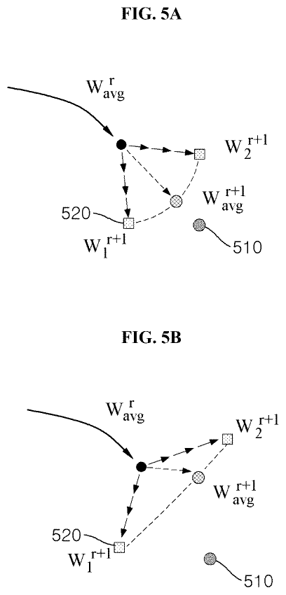

FIG. 5 is a diagram illustrating an operation in which personalized data degrades learning performance, applicable to the present disclosure. Referring to FIG. 5A, a central server may acquire local model training information 520 from each of a plurality of UEs. The central server may update an AI model through an optimization operation that minimizes an error based on the local model training information 520 of the plurality of UEs. That is, the AI model in which the error is minimized may be derived based on the local model training information 520. Here, when the local model training information 520 exhibits IID, performance degradation may occur when the above-described optimization is performed. In contrast, referring to FIG. 5B, when the local model training information 520 exhibits non-IID, performance degradation may also occur when the above-described optimization is performed.

Hereinafter, in consideration of the foregoing, a method of addressing learning performance degradation caused by non-IID characteristics of user data of a UE in an FL system will be described. Specifically, the learning performance degradation caused by the non-IID characteristics may be addressed by correcting a learning trajectory of a model to an optimal point during a learning process utilizing user data at each UE. Specifically, the problem of learning performance degradation due to the non-IID characteristics may be addressed by correcting a learning trajectory of a model toward an optimum during a training process at each UE using user data. That is, before the central server aggregates local models from the respective UEs into an AI model, the local models may be allowed to be trained on user data of other UEs to correct their learning trajectories. In other words, prior to aggregation of the AI model, the local models may be diffused (federated diffusion, hereinafter referred to as “FedDif”) so as to be trained on the user data (or data sets) of the other UEs, and a detailed method thereof will be described below.

For example, in a conventional AI model training paradigm, optimization may be performed based on stochastic gradient descent (SGD). The SGD is an optimization algorithm that uses a gradient of a loss function to adjust weights of a model. In the SGD, the gradient of the loss function is calculated only for a randomly selected data sample and the weights of the model are updated based on the calculated gradient. Accordingly, the model can be trained at a high speed because calculations are performed only on some samples rather than on an entire data set. The SGD may use data samples configured based on a mini-batch size in a large-scale data set, and a learning speed and accuracy may be controlled by adjusting the mini-batch size. For example, in the conventional AI learning paradigm, a single IID data set may be divided into mini-batches composed of data samples, and optimization may be performed once for each mini-batch. Although SGD-based optimization may incur some loss in optimization performance, it can increase learning speed and reduce computational complexity.

Hereinafter, in consideration of the above-described SGD, a method for updating a model of FL will be described. For example, in the FL, each UE (or user) may be treated as a single mini-batch. In this case, the UE needs to make a cumulative data distribution that the UE has used for training the AI model become identically distributed. For example, the UE may cause a cumulative data distribution that the UE has used for training the AI model to become identically distributed by applying a local model of a specific other UE to the cumulative data distribution. To achieve this, a FedDif operation for identifying a specific UE among a plurality of UEs that have performed training and efficiently diffusing the AI model may be required, and this will be described below.

For example, as local models are diffused in the system based on FedDif, the number of transmissions of the local models may increase, and communication costs generated in the process of performing training by this operation may increase linearly. Therefore, it is necessary to minimize communication costs incurred in a single communication and the number of transmissions of the model.

For example, in order to minimize the communication costs incurred in the single communication, transmission of the local model may be performed based on device-to-device (D2D) communication between terminals in a WLAN. Here, the WLAN may correspond to communication performed based on a local area network (LAN), and communication may be performed based on Wi-Fi or other technologies. For example, local model information may be exchanged between terminals via the WLAN. In another example, D2D communication may be performed based on a wireless communication network. D2D communication may be referred to as sidelink, V2X, or another term, and is not limited to any particular form. D2D communication may support communication between terminals via a wireless communication network based on 5G communication. In addition, in a next-generation communication system, data exchange between terminals may also be performed based on D2D communication or sidelink communication, and is not limited to any particular form.

That is, the local model information may be exchanged between terminals to receive local model information from other UEs so that the cumulative data distribution learned by the UE becomes identically distributed. Here, in order to minimize the number of transmissions of the AI model, a degree of learning (DoL), which represents a cumulative data distribution learned by the UE based on the AI model, and an IID distance, which represents how close the DoL is to an identically distributed state, may be utilized.

For example, diffusion efficiency may represent a rate of reduction in IID distance relative to communication costs incurred by all UEs participating in FL. Based on the foregoing, using auction theory, an auction may be designed to find a next trainer UE that maximizes diffusion efficiency within the system. The auction theory may correspond to a method in which there exist multiple entities participating in the bidding process and a specific entity is selected through an auction designed to acquire a best outcome among the plurality of entities. For example, in the auction, a valuation of each UE for an AI model may be determined according to a rate of reduction in IID distance based on a learning rate. Here, each UE may quantify to what extent its data set can reduce an IID distance with respect to a DoL of each AI model, and may submit a bid to the central server.

The central server may calculate diffusion efficiency using wireless channel state information (CSI) between UEs and bid information, and may select, for each AI model, a next trainer UE that maximizes the diffusion efficiency. Thereafter, diffusion efficiency may be maximized by performing a diffusion configuration for other UEs using information on the selected next trainer UE.

Based on the foregoing, FedDif may prevent a deviation from an optimal learning trajectory that may occur during training and aggregation of the AI model in the FL. Specifically, deviation from an optimal learning trajectory may correspond to a case in which a divergence problem occurs as a result of diverging weights of the AI model compared to weights of a model for which optimization has progressed.

Here, the FedDif may be a series of processes that, in consideration of the fact that an IID data set can be generated by combining non-IID data sets, utilize an IID distance to select a next trainer UE that minimizes the IID distance at current DoL values of AI models. Based on the foregoing, the FedDif may address a weight divergence problem that may occur due to non-IID data sets.

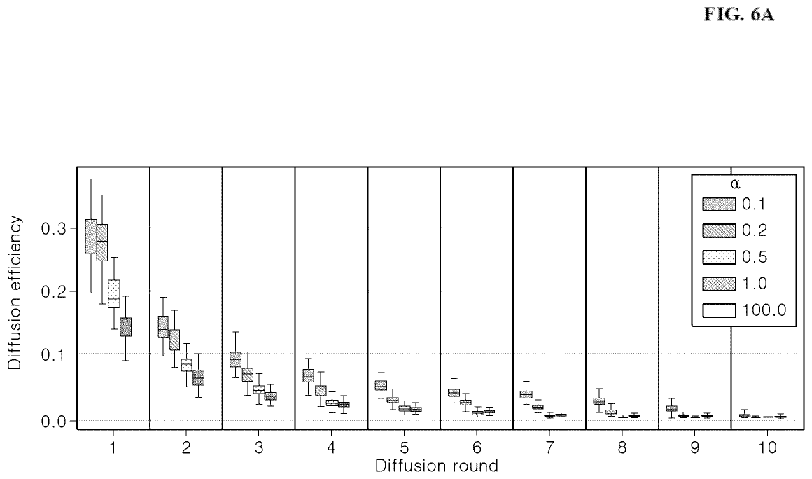

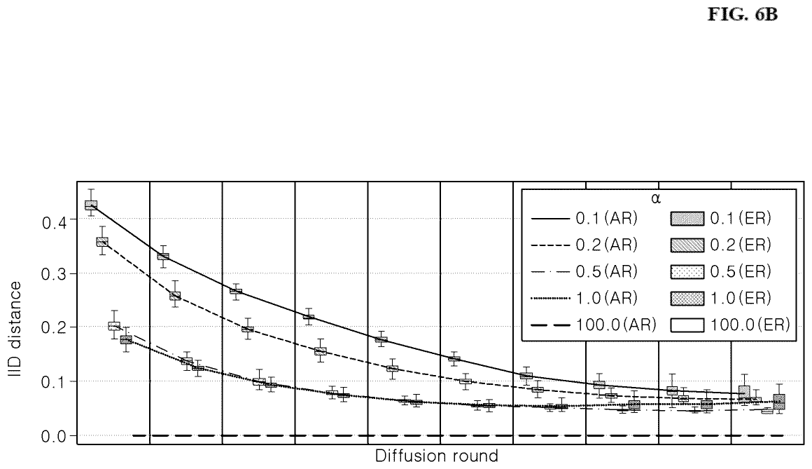

For example, FIGS. 6A and 6B are diagrams illustrating a method of minimizing a diffusion efficiency by minimizing an IID distance with respect to UEs having non-IID datasets, applicable to the present disclosure. Referring to FIGS. 6A and 6B, these graphs illustrate whether the IID distance and the diffusion efficiency converge to 0 as diffusion rounds progress. Here, in the simulation environment of FIGS. 6A and 6B, the number of UEs is 10, and the UEs may be uniformly distributed in a circular system having a radius of 250 m. However, this is merely one example for convenience of explanation, and the present disclosure is not limited thereto.

For example, data sets of UEs may be allocated by dividing a CIFAR-10 data set into ten non-IID data sets based on a Dirichlet distribution. In addition, wireless channel and frame modeling may be based on a channel model and numerology specified in a 5G standard, but the present disclosure is not limited thereto. Furthermore, transmit powers used for communication with a central server and for D2D communication may be set to 40 dBm and 23 dBm, respectively. Since transmission and reception of models between UEs are performed via D2D communication, signal strength attenuation due to distance may be more severe. However, because a distance between UEs is relatively shorter than a distance between the central server and each UE, high-quality communication may be achieved even with low transmit power.

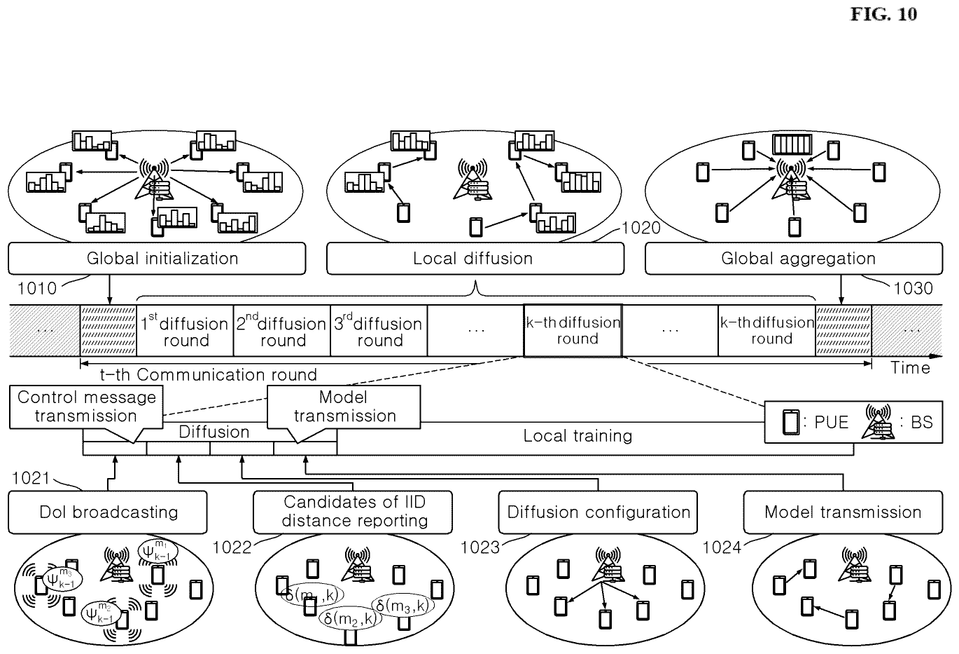

For example, the FedDif may include two parameters for controlling a degree of diffusion in consideration of hyperparameter tuning for training an AI model and communication parameters. A first parameter is a minimum tolerable IID distance ϵ When data of UEs in a system are variously distributed for each class, an IID distance can theoretically be made to converge to 0, but, in practice, an error may exist. Accordingly, the minimum tolerable IID distance ϵ may be a minimum threshold for stopping diffusion when the IID distance has decreased and may be set by an administrator. As shown in FIGS. 6A and 6B, as diffusion rounds progress, the IID distance and the diffusion efficiency may converge to 0. Based on this, a specific method for efficient diffusion of an AI model for improving performance of an FL system will be described hereinafter with reference to FIG. 10.

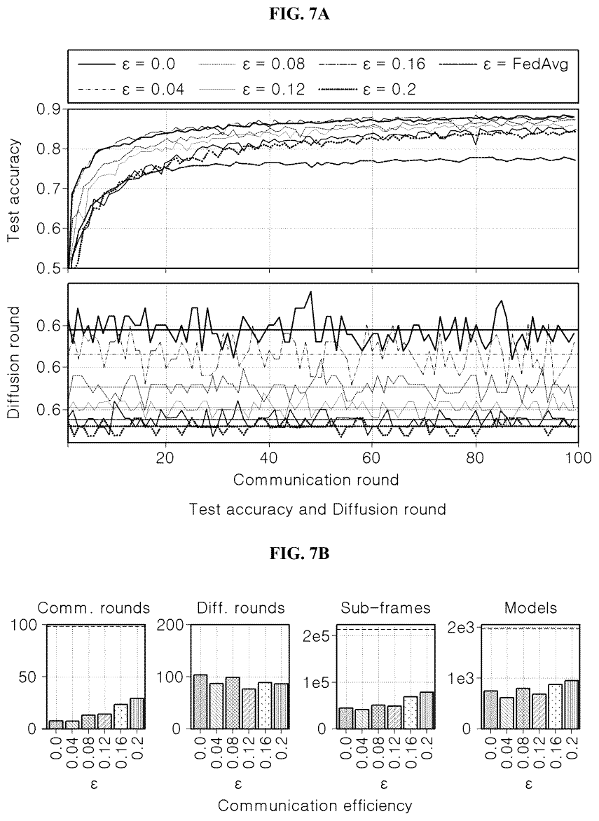

In addition, for example, FIGS. 7A and 7B are graphs comparing learning performance and communication costs, applicable to the present disclosure. Referring to FIGS. 7A and 7B, as the minimum tolerable IID distance ϵ becomes smaller, the learning performance of an AI model may increase, but more diffusion iterations may be required.

In addition, a second parameter may be a minimum tolerable quality of service γ̅ₘᵢₙ. As described above, when a next trainer UE is located on a diametrically opposite side of the system after an auction for diffusion is performed, a distance between a current UE and the next trainer UE may become significantly large. Accordingly, communication costs may increase exponentially. In consideration of the foregoing, a minimum threshold may be required for diffusing a model while guaranteeing a certain level or higher of communication quality, and such a threshold may be set by an administrator.

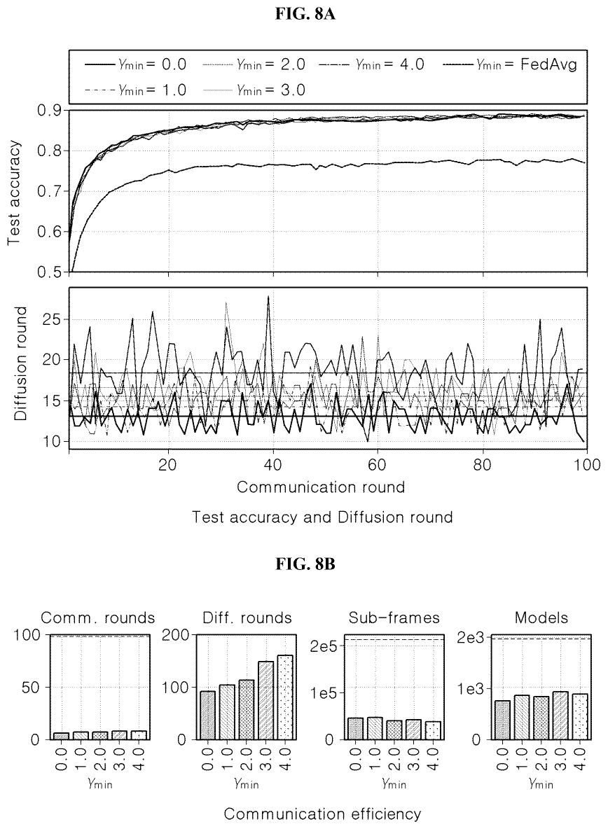

For example, FIGS. 8A and 8B are graphs comparing learning performance and communication costs, applicable to the present disclosure. Referring to FIGS. 8A and 8B, although a difference in the learning performance is small, as the minimum tolerable quality of service γ̅ₘᵢₙ increases, the number of diffusion iterations required for optimization may increase. For example, in the simulation environment of FIGS. 8A and 8B, since the size of the system is relatively small, the change is not significant. However, as the size of the system increases, a difference in performance with respect to a corresponding parameter may become larger.

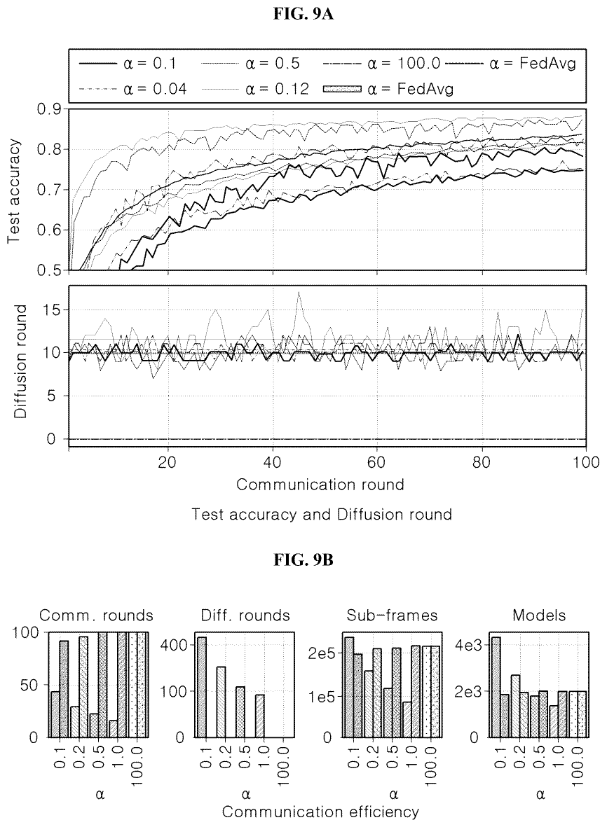

In addition, for example, a degree of non-IID characteristics of a data set may be determined by a concentration parameter α of a Dirichlet distribution, and as the value of the concentration parameter α becomes smaller, the data set may deviate further from an IID distribution. FIGS. 9A and 9B are graphs comparing learning performance and communication cost, applicable to the present disclosure. Referring to FIGS. 9A and 9B, as the concentration parameter α becomes smaller, the learning performance itself becomes significantly low, and communication costs required to achieve target learning performance may significantly increase. However, FedDif may always exhibit higher performance than basic FL.

For example, in a conventional scheme, exchange of AI models between UEs may be performed randomly by the central server. Here, based on the foregoing, the weight divergence problem may not be resolved. For example, when only UEs that increase the IID distance remain in the system, a learning trajectory of an AI model at the central server may deviate farther from an optimal trajectory than in the basic FL. On the other hand, since FedDif is a process of solving a diffusion-efficiency maximization problem, diffusion of a model that would cause deviation from the optimal trajectory may not be performed.

As another example, in a conventional scheme, when local models are transmitted to the central server without consideration of communication costs, the central server may randomly reshuffle the local models without aggregating the local models into a global model and transmit them back to the UEs. However, when UEs participating in the above-described learning process and UEs not participating in the learning process are scheduled together, communication quality of the UEs not participating in the learning process may be degraded. In contrast, when diffusion is performed using FedDif, the FedDif may not only theoretically guarantee resolution of a weight divergence problem, but may also perform optimization of diffusion in a communication-efficient manner, and thus may solve the problem more efficiently than conventional techniques.

FIG. 10 is a diagram illustrating a FedDif operation procedure applicable to the present disclosure. Referring to FIG. 10, the central server may broadcast a copy of a global model based on an AI model to a plurality of UEs. For example, the process of the central server broadcasting the copy of the global model to the plurality of UEs may be global initialization 1010. Thereafter, the plurality of UEs may transmit local model information, trained based on their respective data sets, to the central server. That is, the central server may aggregate the trained local model information from each of the plurality of UEs, and this process may be global aggregation 1030. Here, for example, between global initialization 1010 and global aggregation 1030 in FIG. 10, local diffusion 1020 may further be performed. Specifically, a process in which the central server trains the AI model through global initialization 1010, local diffusion 1020, and global aggregation 1030 may be performed in accordance with a predetermined cycle. For example, T communication rounds may be carried out for FL. FIG. 10 may illustrate a tth communication round among the T communication rounds. However, this is merely one example for convenience of explanation, and the present disclosure is not limited thereto.

Here, for example, within a single communication round, after global initialization 1010 is performed, local diffusion 1020 may be performed. A goal of local diffusion 1020 may be to minimize communication costs and maximize learning performance with a minimum amount of diffusion, while preserving user privacy, which is a fundamental principle of FL. Therefore, the detailed processes constituting local diffusion 1020 must ensure that the UE's data samples themselves or their distributions cannot be inferred. In consideration of the foregoing, the detailed processes may utilize the above-described DoL as a cumulative distribution of training data of the model, rather than a data distribution of the UE. The DoL may be a DoL that represents a cumulative data distribution learned by an AI model, as described above.

Transmission and reception in consideration of local diffusion may be performed through a D2D overlay mode in which channels used for cellular mobile communication are shared. That is, a UE may perform D2D communication using a channel used for communication with a central server (or base station). As another example, D2D communication may operate based on a mode scheduled and controlled by the central server (or base station) or a mode directly scheduled and controlled by the UE, but may not be limited to a particular form.

Here, FedDif may need to be performed in consideration of a state of data sets, a DoL of models, channel states for communication, and other factors. For example, referring to FIG. 10, a central server and a plurality of UEs participating in FL may exist in the system. As a specific example, a case where N terminals exist in the system and Nₚ terminals participate in the FL may be considered. However, this is merely an example for convenience of explanation and may not be limited thereto.

A data set of an ith terminal participating in the FL is generated according to a probability density function P(Xᵢ) of a random variable Xᵢ, and may be denoted by [symbol] . Here, the size of the data set [symbol] is Dᵢ. Since data sets among UEs have non-IID characteristics, distributions of terminals i and j satisfy P(Xᵢ)≠P(Xⱼ). Data state information (DSI) of terminal i may be defined as a ratio of data samples for each class and may be represented as dᵢ˜ [symbol] . In FL, a total of T communication rounds are performed, and in a tth communication round, local diffusion may proceed for a total of Kₜ diffusion rounds. Here, in a kth diffusion round, a set of UEs through which a local model m has passed may be referred to as a diffusion chain and may be expressed as shown in Equation 1.

$${𝒫}_{k}^{( m )} = {𝒫}_{k - 1}^{( m )} ⋃ \{ {i}_{k}^{( m )} \} \qquad [ Equation 1 ]$$

In Equation 1,

$${i}_{k}^{( m )}$$

denotes a UE that trains the local model m in the kth diffusion round. In addition, a total size of all data sets used to train a diffusion chain

$${𝒫}_{k}^{( m )}$$

may be as expressed in Equation 2 below. In addition, in the kth diffusion round, a DoL of the local model m may be as expressed in Equation 3 below.

$${D}_{( {𝒫}_{k}^{( m )} )} = {\sum }_{i ∈ {𝒫}_{k}^{( m )}} {D}_{i} . \qquad [ Equation 2 ]$$

$${ψ}_{k}^{( m )} = \frac{1}{{D}_{( {𝒫}_{k}^{( m )} )}} ( {D}_{( {𝒫}_{k}^{( m )} )} {ψ}_{k - 1}^{( m )} + {D}_{{i}_{k}^{( m )}} {d}_{{i}_{k}^{( m )}} ) \qquad [ Equation 3 ]$$

Here, similarly to DSI, the DoL may denote a ratio of all data samples that the local model m has learned over k diffusion rounds. Here, an IID distance of the DoL

$${ψ}_{k}^{( m )}$$

may be a difference from an identically distributed probability distribution, and may be defined, as shown in Equation 4 below, as a Wasserstein-1 distance (Earth-mover distance). For example, the Wasserstein-1 distance may be a method of calculating a distance between two probability distributions. However, the present disclosure is not limited thereto, and various functions such as Kullback-Leibler divergence (KLD) and Jensen-Shannon distance (JSD) may also be used. For example, based on the foregoing, it may only be necessary to calculate a similarity between the probability distribution and the identically distributed probability distribution. Accordingly, any function capable of expressing such similarity may be applicable, and the present disclosure is not limited to any particular form. For example, in Equation 4, μ and

$$\frac{1}{C} 1$$

may denote an identically distributed probability distribution and DSI corresponding thereto, respectively.

$${W}_{1} ( {ψ}_{k}^{( m )} , 𝒰 ) = ‖ \frac{1}{{D}_{( {𝒫}_{k}^{( m )} )}} ( {D}_{( {𝒫}_{k}^{( m )} )} {ψ}_{k - 1}^{( m )} + {D}_{{i}_{k}^{( m )}} {d}_{{i}_{k}^{( m )}} ) - \frac{1}{C} 1 ‖ \qquad [ Equation 4 ]$$

Next, referring to FIG. 10, local diffusion process 1020 may include DoL broadcasting 1021, candidates of IID distance reporting 1022, diffusion configuration 1023, and model transmission 1024, as well as local training based thereon. For example, DoL broadcasting 1021 may be a process in which all UEs transmit DoLs of local models being trained by each UE to neighboring UEs based on a broadcasting scheme. For example, each UE may, based on the DoLs of local models received using the broadcasting scheme, find a UE that can reduce an IID distance when training the local model. For example, DoL broadcasting 1021 may be performed by broadcasting the DoL to the neighboring UEs based on beacon messages or other types of short messages.

As another example, each UE may transmit its DoL to the central server (or base station) through a physical uplink control channel (PUCCH), and, after collecting the DoLs, the central server may broadcast DoL information on all models again through a physical downlink control channel (PDCCH). In still another example, since the central server is aware of the UEs participating in the FL, the central server may communicate with designated UEs to transmit the above-described information, and the present disclosure is not limited to this particular embodiment. That is, for each UE, the DoL of the local model may be transmitted to at least one UE participating in the FL. Thereafter, in candidates of IID distance reporting 1022, each UE may generate a preliminary DoL by reflecting data state information (DSI) for its own data set in the received DoL. Next, each UE may calculate a candidate of IID distance for the generated preliminary DoL and transmit the candidate of IID distance to the central server (or base station). The central server may derive a difference between an IID distance for a DoL calculated in a previous diffusion round and the received candidate of IID distance, and may perform a valuation for the UEs. Next, the central server may configure an auction based on the valuations for the UEs, as described above.

In diffusion configuration 1023, a next trainer UE may be determined based on an auction, and scheduling for local model exchange may be performed. Specifically, the central server may determine bidding prices for the UEs based on valuations for the UEs, and may perform a winner selection algorithm together with CSI collected in a cellular mobile communication system. For example, Table 1 below may illustrate a winner selection algorithm. However, the winner selection algorithm is not limited to that of Table 1.

Specifically, the central server may calculate a diffusion efficiency based on Equation 5 below by utilizing the bidding prices and the CSI.

TABLE 1
Algorithm 1: Winner selection algorithm

```
$Input : ℳ , {𝒩}_{P} , [ {bid}_{k}^{( 1 )} , … , {bid}_{k}^{( M )} ] , [ {g}_{k}^{( 1 )} , … , {g}_{k}^{( M )}$
$Output : {i}_{k}^{*} , {B}_{k}^{*}$
1 Construct a set of edges (m, i) ϵ ε, ∀m ϵ [symbol]  , i ϵ [symbol]  _{P}
2 Calculate each edge weight c(m, i) by [symbol]
3 Construct a bipartite graph [symbol]   = ( [symbol]  , [symbol]  _{P}, ε)
4 Find the maximal matching [symbol]  * ⊆ [symbol]   × [symbol]  _{P} by Kuhn-
    Munkres algorithm
$5 Select auction winners {i}_{k}^{*} = [ \{ i : ( m , i ) ∈ {ℛ}^{*} \} ]$
6 Allocate communication resources
    ${B}_{k}^{*} = [ \{ {\tilde{B}}_{i , k}^{( m )} : ( m , i ) ∈ {ℛ}^{*} \} ]$
```

$$E ( {i}_{k} , {B}_{k} ) = \frac{1}{M} {\sum }_{m ∈ ℳ} \frac{{δ}_{{i}_{k}^{( m )}}}{{B}_{k}^{( m )}} \qquad [ Equation 5 ]$$

Here, the bidding prices may be as expressed in Equation 6 below, and

$${B}_{k}^{( m )}$$

in Equation 5 may be as expressed in Equation 7 below. For example,

$${B}_{k}^{( m )}$$

may be a bandwidth required for model transmission, which can be calculated from CSI.

$${δ}_{{i}_{k}^{( m )}} = {W}_{1} ( {ψ}_{k - 1}^{( m )} , 𝒰 ) - {W}_{1} ( {ψ}_{k}^{( m )} , 𝒰 ) \qquad [ Equation 6 ]$$

$${B}_{k}^{( m )} = \frac{S}{{γ}_{{i}_{k - 1}^{( m )} , {i}_{k}^{( m )}}^{( k )}} \qquad [ Equation 7 ]$$

In Equation 7,

$${γ}_{{i}_{k - 1}^{( m )} , {i}_{k}^{( m )}}^{( k )}$$

denotes a signal-to-noise ratio (SNR) between a UE

$${i}_{k - 1}^{( m )}$$

that trained the local model m in a (k−1)th diffusion round and a UE

$${i}_{k}^{( m )}$$

that trained the local model m in a kth diffusion round, and may be the same as CSI.

For example, the central server may use the calculated diffusion efficiency to derive an optimal matching between a current UE and a next trainer UE through a Hungarian algorithm (Kuhn-Munkres algorithm). Next, the central server may perform scheduling for diffusion based on the derived matching and a basic radio resource allocation algorithm. Model transmission 1024 and local training may be processes in which transmission and reception of local models between UEs are performed based on scheduling by the central server, and training is performed at each UE based on the local model received by the UE.

For example, DoL broadcasting 1021, candidates of IID distance reporting 1022, and diffusion configuration 1023 correspond to significantly small control message transmissions, and therefore, do not consume a large amount of transmission resources, and communication costs thereof may also be significantly small. However, in model transmission 1024, since transmission and reception of local models are performed, a larger amount of transmission resources may be used. Based on the foregoing, a method of minimizing a number of diffusion rounds may be required. For example, Table 2 below may illustrate an algorithm for an overall operation of FedDif that minimizes the number of diffusion rounds, but the present disclosure is not limited thereto.

TABLE 2
Algorithm 2: FedDif

Input: η, [symbol] _{P}, [symbol] , T, γₘᵢₙ, ε
$Output : {w}_{T}^{( g )}$

$1 Initialize the global model {w}_{0}^{( g )} and broadcast the$

| | hyperparameters, such as the learning rate η to PUEs. | | | |
|---|---|---|---|---|
| 2 | foreach communication round t = 1, 2, ..., T do | | | |
| 3 | \| | BS broadcasts the models [symbol] to PUEs. | | |
| 4 | \| | $k = 0 , {𝒫}_{k}^{( m )} = ∅ , {D}_{\{ {𝒫}_{k}^{( m )} \}} = 0 , {ψ}_{k}^{( m )} = 0$ | | |
| 5 | \| | foreach Model m ϵ [symbol] in parallel do | | |
| 6 | \| | \| | $Trainer PUE {i}_{k}^{( m )} of the model m forms the$ | |
| | \| | \| | $local dataset {𝒟}_{{i}_{k}^{( m )}} with the DSI {d}_{{i}_{k}^{( m )}} .$ | |
| 7 | \| | \| | ${w}_{t , k}^{m} , {𝒫}_{k}^{m} ← LocalUpdate ( k , m , {i}_{k}^{m} )$ | |
| 8 | \| | end | | |
| 9 | \| | $while IID distance {W}_{1} ( {ψ}_{k}^{( m )} , 𝒰 ) > ε do$ | | |
| 10 | \| | \| | k ← k + 1 | |
| 11 | \| | \| | foreach PUE i ϵ [symbol] _{P} do | |
| 12 | \| | \| | \| | $Broadcast DoL {ψ}_{k - 1}^{( m )} to the other PUEs .$ |
| 13 | \| | \| | \| | $Calculate valuation {v}_{i , k}^{( {m}^{′} )} of the received$ |
| | \| | \| | \| | $DoL {\tilde{ψ}}_{k}^{( {m}^{′} )} of the model {m}^{′} .$ |
| 14 | \| | \| | \| | $Transmit {bid}_{k}^{( m )} and {g}_{k}^{( m )} to BS .$ |

| | | | |
|---|---|---|---|
| 15 | \| | \| | end |
| 16 | \| | \| | $BS determines {i}_{k}^{*} and {B}_{k}^{*} by Alg . and$ |
| | \| | \| | schedules PUEs. |
| 17 | \| | \| | schedules PUEs transmit their local model. |
| 18 | \| | \| | foreach Model m ϵ [symbol] do |
| 19 | \| | \| | ${w}_{t , k}^{m} , {𝒫}_{k}^{m} ← LocalUpdate ( k , m , {i}_{k}^{m} )$ |
| 20 | \| | \| | end |

| 21 | \| | end |
|---|---|---|
| 22 | \| | ${w}_{t}^{g} = {\sum }_{m ∈ ℳ} \frac{{D}_{( {𝒫}_{k}^{m} )}}{{\sum }_{{m}^{′} ∈ ℳ} {D}_{( {𝒫}_{k}^{{m}^{′}} )}} {w}_{t , k}^{m}$ |
| 23 | end | |
| 24 | $Function LocalUpdate ( k , m , {i}_{k}^{m} ) :$ | |
| 25 | \| | ${𝒫}_{k}^{m} = {𝒫}_{k - 1}^{m} ⋃ \{ {i}_{k}^{m} \}$ |
| 26 | \| | ${D}_{( {𝒫}_{k}^{m} )} = {D}_{( {𝒫}_{k - 1}^{m} )} + {D}_{{i}_{k}^{m}}$ |
| 27 | \| | ${ψ}_{k}^{m} = \frac{1}{{D}_{( {𝒫}_{k}^{m} )}} ( {D}_{( {𝒫}_{k - 1}^{m} )} {ψ}_{k - 1}^{m} + {D}_{i} {d}_{{i}_{k}^{m}} )$ |
| 28 | \| | ${w}_{t , k}^{m} = {w}_{t , k - 1}^{m} - η ∇ {𝔼}_{x , y ∼ P ( {X}_{{i}_{k}^{m}} )} [ l ( {w}_{t , k - 1}^{m} ; x ) ]$ |
| 29 | \| | $return {w}_{t , k}^{m} , {𝒫}_{k}^{m}$ |

| | |
|---|---|
| 30 | end |

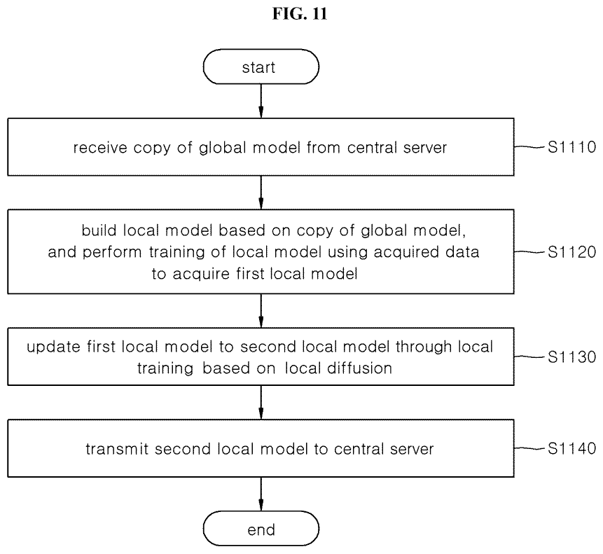

FIG. 11 is a flowchart illustrating a communication-efficient artificial intelligence model diffusion method for improving performance of an FL system, applicable to the present disclosure. Referring to FIG. 11, in an FL system, in operation S1110, a UE for diffusing an AI model may receive a copy of a global model from a central server. Next, in operation S1120, the UE may build a local model based on the copy of the global model and perform training of the local model using data acquired by the UE, thereby obtaining a first local model. That is, the first local model may refer to a local model that has been trained by the UE using data acquired by the UE itself. Next, in operation S1130, the UE may update the first local model to a second local model through local training based on local diffusion. For example, when the UE is selected as a next trainer UE according to local diffusion, the first local model and the second local model may be identical. In contrast, when the UE is not selected as the next trainer UE and a local model is acquired from another UE, the first local model may be updated to the second local model by reflecting the local model of another UE. That is, the second local model may be a local model trained by reflecting a local model of the next trainer UE. Next, in operation S1140, the UE may transmit the second local model to the central server. Here, for example, the UE may include a memory, a transceiver, and a controller configured to control the memory and the transceiver, and the controller may perform the above-described operations.

For example, the UE may be a UE that participates in FL based on the central server. In addition, when local training is performed in a first diffusion round, the UE may transmit a DoL to a plurality of UEs participating in the FL based on the central server. Here, the DoL may represent a cumulative data distribution learned by the local model using data acquired by the UE, as described above.

As a specific example, the DoL may be transmitted to the plurality of UEs participating in the FL using a broadcasting scheme or transmitted to the central server via an uplink control channel, and then transmitted, by the central server, to the plurality of UEs participating in the FL, as described above.

Next, the UE may receive the DoL from each of the plurality of UEs participating in the FL and may generate a preliminary DoL by reflecting data state information (DSI) of the data set of the first local model in each DoL. In addition, the UE may derive a first candidate IID distance based on the preliminary DoL and transmit the first candidate IID distance to the central server.

The central server may derive bidding price information by calculating a difference between a second candidate IID distance, derived in a second diffusion round, and the first candidate IID distance. Here, the second diffusion round may be a diffusion round prior to the first diffusion round.

The central server may determine a next trainer UE by deriving bidding price information for each of the plurality of UEs participating in FL and performing UE valuation. For example, the central server may determine the next trainer UE through UE valuation by further considering channel state information (CSI) for each of the plurality of UEs, as described above.

Here, when the UE is determined as the next trainer UE, the UE may transmit the first local model to the plurality of UEs participating in FL based on a D2D scheme. On the other hand, when the UE is not determined as the next trainer UE, the UE may receive, from the next trainer UE, the local model of the next trainer UE based on the D2D scheme. Thereafter, the UE may perform training based on the local model of the next trainer UE to acquire the second local model.

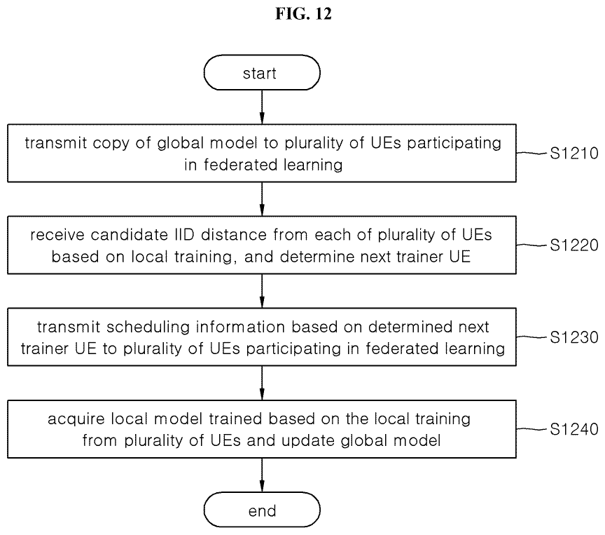

FIG. 12 is a flowchart illustrating a communication-efficient AI model diffusion method for improving performance of an FL system, applicable to the present disclosure.

Referring to FIG. 12, in an FL system, in operation S1210, a central server for diffusing an AI model may transmit a copy of a global model to a plurality of UEs participating in FL. Here, each of the plurality of UEs may build a local model based on the copy of the global model and perform training of the local model using data acquired by each of the plurality of UEs.

Next, in operation S1220, when local training is performed based on local diffusion, the central server may receive a candidate IID distance from each of the plurality of UEs based on the local training and may determine a next trainer UE. Next, in operation S1230, the central server may transmit scheduling information based on the determined next trainer UE to the plurality of UEs participating in FL. Next, in operation S1240, the central server may acquire local models trained based on the local training from the plurality of UEs and may update the global model. Here, the central server may include a memory, a transceiver, and a controller configured to control the memory and the transceiver, and the controller may perform the above-described operations.

For example, the central server may derive bidding price information by acquiring a candidate IID distance from each of the plurality of UEs participating in FL, and determine a next trainer UE by performing UE valuation in consideration of the bidding price information and CSI, as described above.

Here, the next trainer UE may transmit the local model to the plurality of UEs participating in FL based on a D2D scheme. Thereafter, in global aggregation, the central server may update the global model by acquiring the local model updated from each of the plurality of UEs participating in the FL and may update the global model.

As described above, according to an embodiment of the present disclosure, in order to address a weight divergence problem and a privacy leakage problem caused by non-IID data in an FL system, a new diffusion strategy (referred to as federated diffusion (FedDif)) for a machine learning (ML) model is provided. In the FedDif, a UE propagates local models to neighboring UEs through D2D communication. The FedDif allows the local model to experience different data distributions before parameter aggregation. It is also theoretically demonstrated that the FedDif may avoid the weight divergence problem. In addition, a communication-efficient diffusion strategy for an ML model, which may determine a trade-off between learning performance and communication costs based on auction theory, is provided. Performance valuation results show that, compared to baseline FL under non-IID settings, the FedDif improves a test accuracy of a global model by 10.37%. In addition, the FedDif reduces the number of consumed subframes by a factor of 1.28 to 2.85 compared to state-of-the-art methods excluding model-compression schemes. The FedDif also increases the number of transmitted models by a factor of 1.43 to 2.67 compared to state-of-the-art methods.

The embodiments of the present disclosure described above may be implemented in various means. For example, embodiments of the present disclosure may be implemented by hardware, firmware, software, or a combination thereof.

In the case of implementation by hardware, methods according to embodiments of the present disclosure may be implemented by one or more application specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, or the like.

In the case of implementation by firmware or software, methods according to embodiments of the present disclosure may be implemented in the form of modules, procedures, functions, or the like that perform the functions or operations described above. Software code may be stored in a memory unit and driven by a processor. The memory unit may be located inside or outside the processor and may exchange data with the processor by various means that are already known.

The present specification has the effect of providing a communication-efficient AI model diffusion method for improving performance of an FL system.

The present specification has the effect that performance of an FL system can be improved by performing optimization using a DoL of an AI model and an IID distance with respect to a proximity of the DoL to an identically distributed distribution.

The present specification has the effect of improving performance by adding a local diffusion process to an FL system.

The present specification has the effect of providing a method for a specific operation of a local diffusion process.

The effects of the present disclosure are not limited to the effects mentioned above, and other effects not mentioned will be clearly understood by those skilled in the art from the above detailed description.

The detailed description of exemplary embodiments of the present disclosure disclosed above has been provided to enable those skilled in the art to implement and practice the present disclosure. While the above has been described with reference to the exemplary embodiments of the present disclosure, those skilled in the art will appreciate that various modifications and variations can be made to the present disclosure without departing from the spirit and scope of the present disclosure as set forth in the claims below. Accordingly, the present disclosure is not intended to be limited to the embodiments disclosed herein but is to be accorded the widest scope consistent with the principles and novel features disclosed herein. In addition, although the exemplary embodiments of the present specification have been illustrated and described above, the present specification is not limited to the specific embodiments described above, and various modifications may be made by a person having ordinary skill in the art to which the invention pertains without departing from the gist of the present specification as claimed in the claims, and such modifications should not be individually understood from the technical idea or prospect of the present specification.

In the present specification, both an apparatus invention and a method invention are described, and descriptions of both inventions may be supplementarily applied to each other as needed.

What is claimed is:

1. A method of operating a user equipment (UE) for artificial intelligence (AI) model diffusion in a federated learning (FL) system, the method comprising:
receiving a copy of a global model from a central server;
building a local model based on the copy of the global model and acquiring a first local model by performing training of the local model using acquired data;
updating the first local model to a second local model through local training based on local diffusion; and
transmitting the second local model to the central server.

2. The method of claim 1, wherein the UE is a UE that participates in the FL system based on the central server.

3. The method of claim 2, wherein, when the local training is performed in a first diffusion round, the UE transmits a degree of learning (DoL) to a plurality of UEs participating in the FL system based on the central server, the DoL representing a cumulative data distribution learned by the local model using the acquired data.

4. The method of claim 3, wherein the DoL is transmitted to the plurality of UEs participating in the FL system based on a broadcasting scheme.

5. The method of claim 3, wherein the DoL is transmitted to the central server via an uplink control channel, and
the central server transmits the DoL to the plurality of UEs participating in the FL via a downlink control channel.

6. The method of claim 3, wherein the UE receives the DoL from each of the plurality of UEs participating in the FL system,
generates a preliminary DoL by reflecting data state information (DSI) of the first local model on each DoL, and
derives a first candidate independent and identically distributed (IID) distance based on the preliminary DoL to transmit the first candidate IID distance to the central server.

7. The method of claim 6, wherein the central server derives bidding price information by calculating a difference between a second candidate IID, which is derived in a second diffusion round, and the first candidate IID, the second diffusion round being a diffusion round prior to the first diffusion round, and
the central server derives bidding price information for each of the plurality of UEs participating in the FL system and determines a next trainer UE through UE valuation.

8. The method of claim 7, wherein the central server further considers channel state information (CSI) for each of the plurality of UEs and determines the next trainer UE through the UE valuation.

9. The method of claim 8, wherein, when the UE is determined to be the next trainer UE, the UE transmits the first local model to the plurality of UEs participating in the FL system based on a device-to-device (D2D) scheme.

10. The method of claim 8, wherein, when the UE receives a local model of the next trainer UE from the next trainer UE based on a D2D scheme, the UE performs training based on the local model of the next trainer UE to acquire the second local model.

11. A method of operating a central server for artificial intelligence (AI) model diffusion in a federated learning (FL) system, the method comprising:
transmitting a copy of a global model to a plurality of user equipments (UEs) participating in FL, wherein each of the plurality of UEs builds a local model based on the copy of the global model and performs training of the local model using data acquired by each of the plurality of UEs;
determining a next trainer UE by receiving a candidate independent and identically distributed (IID) distance from each of the plurality of UEs based on local training;
transmitting scheduling information based on the determined next trainer UE to the plurality of UEs participating in the FL; and
updating the global model by acquiring local models trained based on the local training from the plurality of UEs.

12. A user equipment (UE) that performs artificial intelligence (AI) model diffusion in a federated learning (FL) system, the UE comprising:
a memory;
a transceiver; and
a controller configured to control the memory and the transceiver,
wherein the controller is configured to:
receive a copy of a global model from a central server;
build a local model based on the copy of the global model and perform training of the local model using acquired data to acquire a first local model;
update the first local model to a second local model through local training based on local diffusion; and
transmit the second local model to the central server.

13. The UE of claim 12, wherein the UE is a UE that participates in the FL system based on the central server, and
when the local training is performed in a first diffusion round, the UE transmits a DoL to a plurality of UEs participating in the FL system based on the central server, the DoL representing a cumulative data distribution learned by the local model using the acquired data.

14. The UE of claim 13, wherein the DoL is transmitted to the plurality of UEs participating in the FL system based on a broadcasting scheme.

15. The UE of claim 13, wherein the DoL is transmitted to the central server via an uplink control channel, and
the central server transmits the DoL to the plurality of UEs participating in the FL system via a downlink control channel.

16. The UE of claim 13, wherein the UE receives the DoL from each of the plurality of UEs participating in the FL system, generates a preliminary DoL by reflecting DSI of the first local model on each DoL, and derives a first candidate independent and identically distributed (IID) distance based on the preliminary DoL and transmits the first candidate IID distance to the central server.

17. The UE of claim 16, wherein the central server derives bidding price information by calculating a difference between a second candidate IID, derived in a second diffusion round, and the first candidate IID, the second diffusion round being a diffusion round prior to the first diffusion round, and
the central server derives bidding price information for each of the plurality of UEs participating in the FL system and determines a next trainer UE by performing UE valuation through the bidding price information and CSI for each of the plurality of UEs.

18. The UE of claim 17, wherein, when the UE is determined to be the next trainer UE, the UE transmits the first local model to the plurality of UEs participating in the FL system based on a D2D scheme.

19. The UE of claim 17, wherein, when the UE receives a local model of the next trainer UE from the next trainer UE based on a D2D scheme, the UE performs training based on the local model of the next trainer UE to acquire the second local model.

20. A central server that performs artificial intelligence (AI) model diffusion in a federated learning (FL) system, the central server comprising:
a memory;
a transceiver; and
a controller configured to control the memory and the transceiver,
wherein the controller is configured to:
transmit a copy of a global model to a plurality of user equipments (UEs) participating in FL, each of the plurality of UEs building a local model based on the copy of the global model and performing training of the local model using data acquired by each of the plurality of UEs;
determine a next trainer UE by receiving a candidate independent and identically distributed (IID) distance from each of the plurality of UEs based on local training;
transmit scheduling information based on the determined next trainer UE to the plurality of UEs participating in the FL; and
update the global model by acquiring local models trained based on the local training from the plurality of UEs.
